(19) United States
(12) Patent Application Publication
(10) Pub. No.: US 2003/0221677 A1
(43) Pub. Date: Dec. 4, 2003

(54) Device for supplying fuel from a tank to the internal combustion engine of a moter vehicle

(76) Inventor: Christoph Buehler, Gerlingen (DE)

Correspondence Address: RONALD E. GREIGG, GREIGG & GREIGG P.L.L.C., Suite One, 1423 Powhatan Street, Alexandria, VA, 22314, US

(21) Appl. No.: 10/453,668

(22) Filed: Jun. 4, 2003

(30) Foreign Application Priority Data
Jun. 4, 2002 (DE) 1 02 24 696.3

(51) Int. Cl. F04F 5/44; F02M 1/00

(52) U.S. Cl. 123/514; 417/198

(57) ABSTRACT

A suction jet pump for delivering fuel from a tank to an internal combustion is driven by fuel and delivers fuel from a tank into a collecting receptacle of a fuel delivery unit. The pump achieves a greater surface area of the jet with the same volumetric flow of the propulsion jet and the same velocity of the jet, and thus achieves a higher delivery capacity than known devices. The efficiency is increased significantly. A pin is disposed in the cross section of the nozzle outlet, which pin extends into a mixing chamber and increases the surface area of the jet.

### BACKGROUND OF THE INVENTION

1. Field of the Invention

The invention is based on a device for supplying fuel from a tank to the internal combustion engine of a motor vehicle.

2. Description of the Prior Art

Devices of the general type according to the invention are already known, e.g. from DE 198 33 130 A1. These often have delivery capacities that are too low to be able to supply enough fuel for every operating state of an internal combustion engine or have a poor ratio of the aspirated volumetric flow to the volumetric flow of propulsion jet.

Furthermore, DE 197 36 088 A1 has disclosed the placement of a pin in a central nozzle opening, thus producing a fuel jet that widens out like an envelope of a cone, and preventing the fuel jet from directly striking a check valve.

### OBJECT AND SUMMARY OF THE INVENTION

The device according to the invention has the advantage over the prior art that the device is simply improved in that a higher delivery capacity can be achieved with the same propulsion jet quantity than in known devices. This allows the suction jet pump to supply enough fuel, even to a fuel pump with a high delivery capacity.

Advantageous modifications and improvements of the device are possible. For example, it is particularly advantageous to dispose the pin centrally in relation to the nozzle in order to achieve a constant jet velocity and thus a constant suction capacity over the circumference of the jet.

For flow engineering reasons, it is also advantageous for the pin to taper in the downstream direction and to embody the cross section of the pin as circular, for example.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a simplified depiction of a device for supplying fuel from a tank to the internal combustion engine of a motor vehicle, and

FIG. 2 shows a longitudinal section through a detail of the device according to FIG. 1.

### DESCRIPTION OF THE PREFERRED EMBODIMENTS

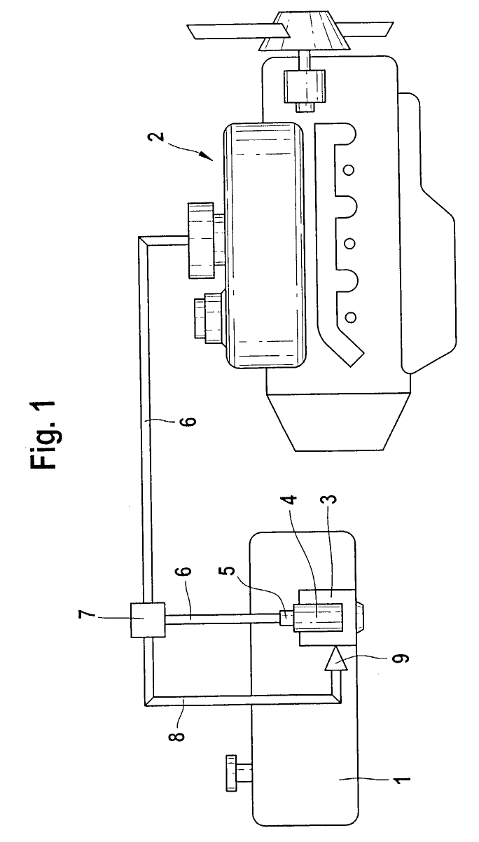

FIG. 1 shows a simplified depiction of a device that can be used, for example, to supply fuel from a tank 1 to the internal combustion engine 2 of a motor vehicle. The tank 1 contains a collecting receptacle 3 from which fuel is drawn by a fuel delivery unit 4 disposed in the collecting receptacle 3. A pressure fitting 5 of the fuel delivery unit 4 is connected to a pressure line 6 that leads to the internal combustion engine 2. The pressure line 6 also contains a pressure regulator 7, which regulates the pressure of the supplied fuel in the pressure line 6 to the system pressure that has been established for the internal combustion engine 2. A return line 8 leads from the pressure regulator 7 back to the tank 1 and fuel that is not needed by the engine 2 flows back to the tank 1 through this return line. The return line 8 is connected to a suction jet pump 9 that is disposed in the tank 1 and feeds fuel into the collecting receptacle 3. During operation of the engine 2, the fuel delivery unit 4 feeds fuel from the collecting receptacle 3 to the engine 2, and the fuel flowing back through the return line 8 drives the suction jet pump 9.

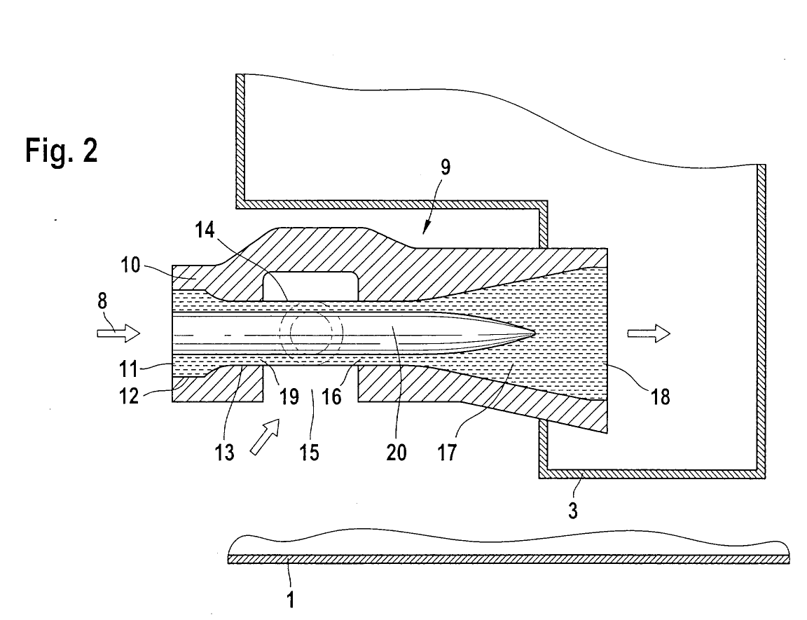

FIG. 2 shows a simplified depiction of the suction jet pump 9 used in FIG. 1. It is comprised of a housing 10 with an inlet opening 11 to be connected to the return line 8. The fuel entering through this inlet opening 11 is then conveyed through an inlet conduit 12 to a nozzle 13 spaced a certain distance after the inlet opening, via whose nozzle outlet 19, fuel travels in the form of a jet 14 into a suction chamber 15. The suction chamber 15 communicates with the tank 1. The jet 14 aspirates fuel from the suction chamber 15. As a result, a replenishing flow of fuel from the tank 1 flows into the suction chamber 15. The aspirated fuel then travels through a mixing chamber opening 16 into a mixing chamber 17, which leads through an outlet opening 18 into the collecting receptacle 3. The cross section of the mixing chamber 17 widens out in the flow direction, for example in a continuous fashion, in order to reduce flow noise.

Upstream of the nozzle outlet 19, a pin 20 begins, whose cross section is smaller than that of the nozzle 13 and that of the nozzle outlet 19, and which extends, for example centrally, downstream into the mixing chamber 17. The pin 20 can be embodied so that it tapers, for example in the flow direction starting from the mixing chamber opening 16. The cross section of the pin 20 can, for example, be circular. The cross section of the pin 20, however, is not limited to a circular cross section; the pin 20 can instead also have an oval, triangular, quadrangular, or other polygonal cross section.

The jet 14 is also referred to as the propulsion jet since it generates the vacuum that drives the suction jet pump 9 and therefore makes it possible for the aspiration of fuel to take place. The greater the surface area of the jet 14, the more fuel can be aspirated over the surface area of the jet 14, which permits the delivery capacity to be increased. A large surface area of the jet 14 is achieved through a large diameter of the nozzle 13. In order to prevent the comparatively large diameter of the nozzle 13 from requiring an excessive volumetric flow of fuel from the return line 8, the pin 20 is disposed for example centrally in relation to the nozzle 13 and reduces the free cross section of the nozzle 13. It is important that the pin 20 extend into the mixing chamber 17 so that the jet 14 is guided downstream of the nozzle outlet 19 and as a result, its large surface area is preserved in a stable fashion. In comparison to known devices, therefore, the device according to the invention achieves a greater surface area of the jet 14 with the same volumetric flow of the propulsion jet and the same velocity of the jet 14, and thus achieves a higher delivery capacity than known devices. The efficiency of the suction jet pump 9, defined by the ratio of the aspirated volumetric flow to the volumetric flow of the propulsion jet, is significantly increased.

The foregoing relates to preferred exemplary embodiments of the invention, it being understood that other variants and embodiments thereof are possible within the spirit and scope of the invention, the latter being defined by the appended claims.

I claim:

1. A pumping device for supplying fuel from a tank to the internal combustion engine of a motor vehicle, comprising
a housing with an inlet opening to be connected to a return line,
a constriction (nozzle) that is disposed spaced a fixed distance downstream of the inlet opening and feeding via a nozzle outlet into a suction chamber connected to the tank,
a mixing chamber that adjoins the suction chamber in the flow direction and leading through an outlet opening into a collecting receptacle, and
a pin disposed in the nozzle, the pin (20) extending from upstream of the nozzle outlet (19), into the mixing chamber (17) and having a cross section smaller than the cross section of the nozzle.

2. The device according to claim 1, wherein the pin (20) is disposed centrally in relation to the nozzle outlet (19).

3. The device according to claim 1, wherein the pin (20) tapers downstream of the nozzle outlet (19).

4. The device according to claim 3, wherein the pin (20) tapers conically downstream of the nozzle outlet (19).

5. The device according to claim 1, wherein the cross section of the pin (20) is embodied as circular.

6. The device according to claim 1, wherein the cross section of the pin (20) is embodied as oval, triangular, quadrangular, or polygonal.
